(19) United States
(12) Patent Application Publication
(10) Pub. No.: US 2020/0200518 A1
(43) Pub. Date: Jun. 25, 2020

(54) STAIR AND RAFTER LAYOUT GUIDE AND LEVEL SYSTEM AND METHOD OF USE

(71) Applicant: James Scribner, Kilworthy (CA)

(72) Inventor: James Scribner, Kilworthy (CA)

(21) Appl. No.: 16/230,190

(22) Filed: Dec. 21, 2018

(51) Int. Cl. G01B 3/56; G01B 3/04; E04F 21/26

(52) U.S. Cl. CPC G01B 3/566; G01B 3/14; E04F 21/26; G01B 3/04

(57) ABSTRACT

A stair guide measuring system is provided including a main body, a measuring square, and a securing means for fixing said measuring square into a fixed and desired position.

### BACKGROUND OF THE INVENTION

A skilled artisan in the building trade is always in search of tools and devices to improve their craft. With the development of significant technological advances, it appears as if many sophisticated devices are available to the artisan. However, there is a particularized skill still requiring manual assistive devices. Those involved in the construction of staircases are often at the mercy of a simple square measuring device. However, this particular square measuring device used for fabrication of staircases is a continual source of problem to the artisan. The present invention provides a unique configuration incorporating the measuring squared into an overall assistive device.

### SUMMARY OF THE INVENTION

As used herein, the term stair guide refers to the present invention that is a system and method for a stair and rafter layout guide and level system.

In one embodiment, the present invention is a stair guide apparatus comprising:
a main body having an upper planar surface and a lower planar surface;
a pair of measuring square receiving slots formed through said main body from top to bottom;
a measuring square;
cavities formed in said main body beginning on said upper planar service terminating at said receiving slots, said cavities constructed and arranged to receive measuring square securing means there through; and
at least one handle cavity formed in said main body.

In one embodiment, the present invention includes at least one spirit level within said system.

In one embodiment, the present invention includes a pair of opposing ends constructed and arranged with shock absorbent material.

In one embodiment, the present invention includes a measuring square securing means include threaded locking bolts.

In one embodiment, the present invention includes a measuring square securing means include circular expanding plugs.

In one embodiment, the present invention is a stair guide apparatus consisting essentially of:
a main body having an upper planar surface and a lower planar surface;
a pair of measuring square receiving slots formed through said main body from top to bottom;
a measuring square;
cavities formed in said main body beginning on said upper planar service terminating at said receiving slots, said cavities constructed and arranged to receive measuring square securing means there through;
at least one handle cavity formed in said main body;
at least one spirit level within said system;
optionally, a pair of opposing ends constructed and arranged with shock absorbent material; and
a measuring square securing means selected from threaded locking bolts or circular expanding plugs.

### BREIF DESCRIPTION OF THE SEVERAL VIEWS OF THE DRAWINGS

FIG. 1 is a plan view according to one embodiment of the present invention.

FIG. 2 is a top view according to one embodiment of the present invention.

FIG. 3 is a rear view according to one embodiment of the present invention.

FIG. 4 is a plan view of the main body with square component removed according to one embodiment of the present invention.

FIG. 5 is a plan view according to one embodiment of the present invention.

FIG. 6 is a plan view according to one embodiment of the present invention.

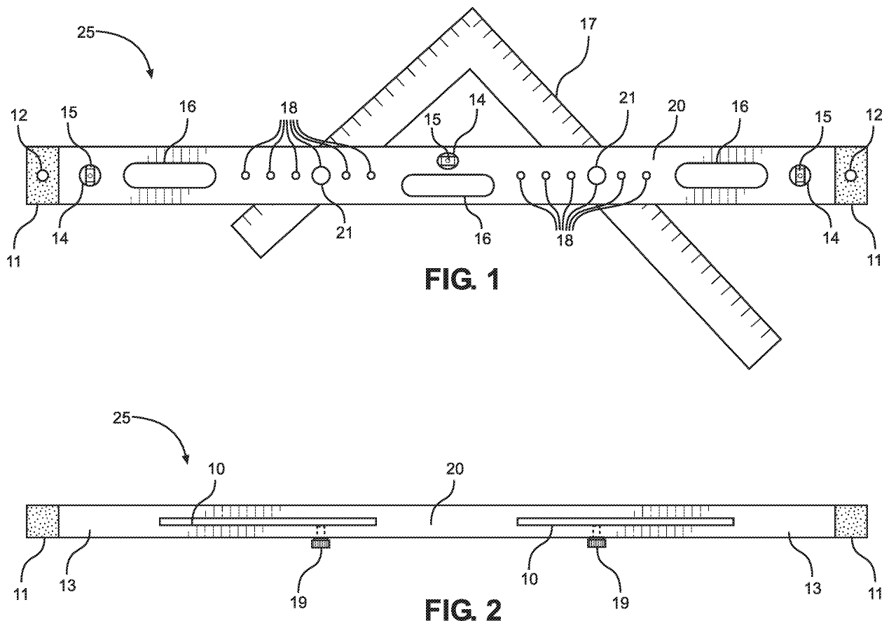

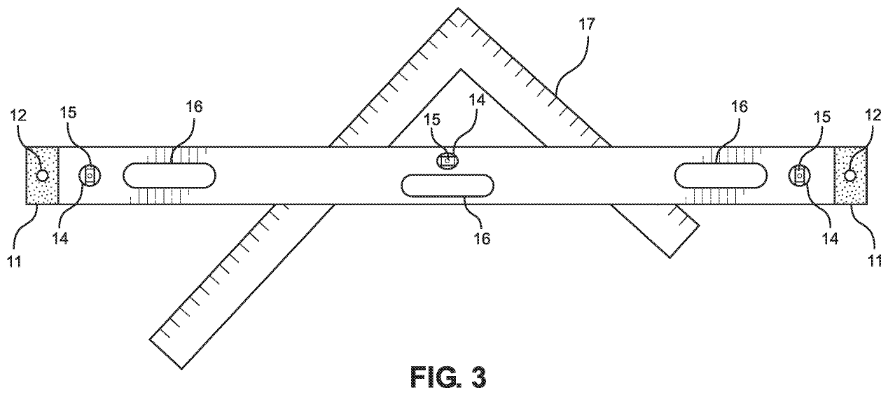

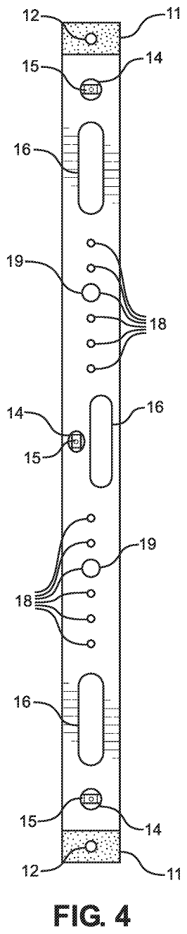

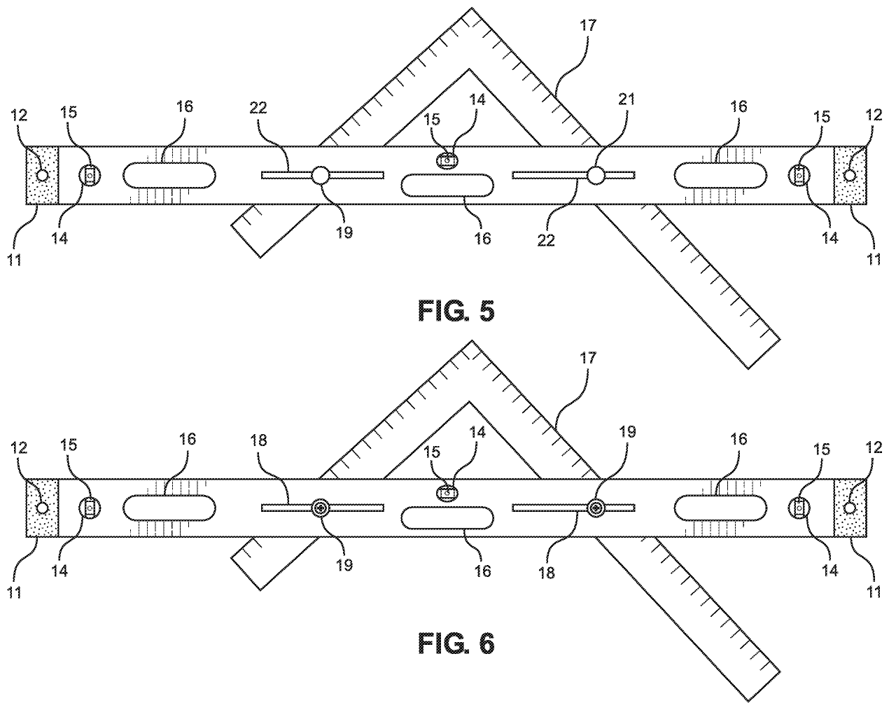

### DETAILED DESCRIPTION OF THE PREFERRED EMBODIMENT

As generally understood the present invention provides for a main tool body 20 constructed and arranged to hold measuring square 17 into a desired and fixed position. Main body 20 has incorporated there with opposing shock absorbent ends 11 each having a circular orifice formed therein. Main body 20 also includes a plurality of openings 14 that are constructed and arranged to hold spirit level 15 within. Main body 20 also includes multiple elongated handle cavities 16 through which a user can grasp and secure main body 20 when using the system of the present invention. main body 20 has a plurality of threaded openings 18 that extends from the top surface of main body 20 only as far as slot opening 10. Each respective slot opening 10 is a measuring square receiving slot and is constructed and arranged to hold measuring square 17 therein.

The system includes magnetic strip 13 configured to allow the body 20 to attach to any magnetic surface while in use. Surfaces include, but are not limited to steel beams, lintels and studs. As understood, the present invention includes one or more spirit levels and in use, the levels are used as needed.

In combination, the invention is a multi use functionality system including the body 20 and at least one spirit level allowing the user to level horizontally or vertically. When system 25 is combined/used with measuring square 17 it is a layout instrument for stairs and rafters providing a unique layout and leveling tool. Thus, the invention provides a multi use functionality not currently known.

The system further includes a threaded bolt 19 constructed and arranged to pair with any threaded opening 18 and configured to secure measuring square 17 into a fixed position. main body 20 further includes threaded slot 22 constructed and arranged to interact with circular expanding plug 21.

As generally understood, the artisan handling system 25 the present invention will fix measuring square 17 into a desired position suitable for measuring angular cuts required for fabricating staircases. In providing a system configured according to the present invention the artisan is insured of exactly duplicating the same angle with multiple measurements thus providing an improved system in the fabrication of staircases.

Once a desired fixed position for measuring square 17 is established, a user will secure measuring square 17 into fixed position utilizing either an embodiment with circular threaded bolt 19 or circular expanding plug 21.

Then the user will position apparatus 25 onto material to be measured and cut. Although positioning activity is typically would be measuring and cutting wood, the present invention contemplates the system being utilized regardless of material to be cut. The user will align the edges of main body 20 with the edge of the material to be cut and draw along the outline of measuring square 17 in order to provide guide lines, or cut lines that will be utilized in cutting material. The user will be able to continually move the system of the present invention along the edge of the material to be cut and with each subsequent movement the identical angle imparted by measuring square 17 will be duplicated. As is generally understood in the art, having a consistent rise and run is of the utmost importance when fabricating and building a staircase.

As is demonstrated herein, providing a guide and square measuring device that consistently maintains a fixed and desired angle will avoid many discrepancies and mistakes even by a skilled artisan.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A stair guide apparatus comprising:
a main body having an upper planar surface and a lower planar surface;
a pair of measuring square receiving slots formed through said main body from top to bottom;
a measuring square;
cavities formed in said main body beginning on said upper planar service terminating at said receiving slots, said cavities constructed and arranged to receive measuring square securing means there through;
and
at least one handle cavity formed in said main body.

2. The stair guide system of claim 1 including at least one spirit level within said system.

3. The stair guide system of claim 1 including a pair of opposing ends constructed and arranged with shock absorbent material.

4. The stair guide system of claim 1 wherein said measuring square securing means include threaded locking bolts.

5. The stair guide system of claim 1 wherein said measuring square securing means include circular expanding plugs.

6.
